(19) United States
(12) Patent Application Publication
(10) Pub. No.: US 2016/0004838 A1
(43) Pub. Date: Jan. 7, 2016

(54) METHODS AND SYSTEMS FOR IMPROVING DRUG INTERACTION PREDICTION AND TREATING BASED ON THE PREDICTIONS

(71) Applicant: Genelex Corporation, Seattle, WA (US)

(72) Inventors: Robert D. Patterson, Lexington, MA (US); Nicolas A. Moyer, Seattle, WA (US); Jessica Oesterheld, Bath, ME (US)

(21) Appl. No.: 14/675,335

(22) Filed: Mar. 31, 2015

Related U.S. Application Data
(60) Provisional application No. 62/020,966, filed on Jul. 3, 2014.

(51) Int. Cl. G06F 19/00; G06F 17/10

(52) U.S. Cl. CPC G06F 19/3437; G06F 17/10

(57) ABSTRACT

Examples described herein include methods and systems for improving accuracy of prediction of substance-factor interactions in patients. Example systems may improve drug interaction prediction for a patient taking a drug by comparing computationally predicted changes in AUC for interaction pairs involving the same metabolic pathways as the drug with change in AUC information from clinical data (e.g. clinical studies). A correction factor for use in the computational prediction may be identified which improves the accuracy of the computational predictions relative to the clinical data. The correction factor may be used to provide improved computational predictions of the change in AUC for a drug, when clinical data may be unavailable. There may be no need for a correction factor if a clinical study is available. The improved computational prediction may be used to set and/or change the amount or identity of the drug administered to a patient.

### CROSS-REFERENCE TO RELATED APPLICATION(S)

This application claims the benefit of the earlier filing date of U.S. Provisional Application 62/020,966 filed Jul. 3, 2014, which provisional application is hereby incorporated by reference in its entirety for any purpose.

### TECHNICAL FIELD

Examples described herein relate to methods and systems for improving predictions of drug interactions, such as through comparison with clinical data, and treating based on the improved predictions.

### BACKGROUND

Traditionally, physicians have been expected to retain in memory knowledge relating to potential adverse drug reactions, pharmacology, and pharmacogenetics, or to have access to such information from published (generally hard-copy) reports—information that is not accessible from a single source and which is increasingly complex. More recently, some classes of information, for example labeling warnings published in the PDR, have become accessible through wireless and PDA devices. There is increasing interest in expanding the availability of this kind of information at the point of care.

A basic problem with all such information, however, is the need for computer systems, databases, networks, and software tools to display and bring to the foreground the information most relevant to the issue at hand, and accuracy of that information. In short, it is no longer sufficient to merely publish information in the form of a text book, reference manual, or published literature. There is a need in the medical arts for methods and systems designed to store and process metabolic, pharmacologic, and/or pharmacogenetic data (which may be referred to herein “metabolomic data”), to interpret that data in the context of patient-specific factors such as, but not limited to, age, pregnancy, smoking and use of alcohol (which may be referred to herein as “clinical factors”, or “patient characteristics”), to make available that data at the point of care, in a manner suitable for a user to interpret and prioritized by relevance, and to provide integrated tools for database updates and maintenance.

Mental Health Connections (Lexington, Mass.) was an early entrant into computerized medical bioinformatics services. Their GeneMedRx service, (originally ‘P450 Drug Interactions’) introduced in 1995, was initially based on computerized tables for looking up drug interactions as a function of induction or inhibition of the cytochrome P450s involved in their metabolism. In 2006, in partnership with Genelex (Seattle Wash.) testing was begun on systems for interpretation of drug-drug and drug-gene interactions within the framework of a patient's overall medication regimen. In recent versions, GeneMedRx has grown as a database and now recognizes transporter and conjugation-linked as well as cytochrome P450-linked drug interactions. The drug interaction service now also includes a predictive algorithm for predicting drug interactions, and was renamed YouScript.

Drug interaction checker software is also available which may check a database of known problematic drug interactions. Such software is typically limited by its ability to identify only specific known interactions which are stored and is generally unable to predict problematic interactions other than those specifically identified for checking.

### SUMMARY

Examples of methods are described herein. An example method for improving drug interaction prediction may include computationally predicting a change percent AUC for a drug based at least in part on an enzyme involved in a metabolic pathway for the drug. Computationally predicting may include utilizing parameters for drug metabolism. The method may further include comparing the computationally predicted change percent AUC with a stored change percent AUC associated with the enzyme, wherein the stored change percent AUC is based on clinical data. The method may further include providing a correction factor for the enzyme based on said analyzing. The correction factor may be used to predict percent AUC change for the drug, or for other drugs utilizing the same enzyme, and the updated percent AUC change may be utilized in treating patients.

### BRIEF DESCRIPTION OF THE DRAWINGS

FIG. 1 is a block diagram of a method for improving drug interaction prediction by comparing computationally predicted change in AUC with change in AUC based on clinical data arranged in accordance with examples described herein.

FIG. 2 is a block diagram of an example of a system for improving drug interaction prediction arranged in accordance with examples described herein.

FIG. 3 is a block diagram of an example of a system for improving drug interaction prediction arranged in accordance with examples described herein.

FIG. 4 is an illustration of an example of presentation of output of computational prediction arranged in accordance with examples described herein.

FIG. 5 is an illustration of an example of presentation of output of computational prediction arranged in accordance with examples described herein.

### DETAILED DESCRIPTION

Examples described herein relate generally to predicting drug interactions. Generally, examples may involve predicting a change in area under the curve (AUC) for substance-factor interactions (e.g. drug interactions with other drugs, genes, or other factors, for instance, environmental factors, food, patient habits etc.), and may involve improved prediction of change in AUC for substance-factor interactions after applying correction factors, which may be derived from clinical studies. The correction factors may be derived from a comparison between a computational prediction and clinical data. For example, a computational prediction (e.g. predictive algorithm) may be run on a variety of substance-factor groups (pairs or groups with greater than one interactor), and the computational prediction of change in AUC may be compared with clinical data on those substance-factor groups. A substance-factor pair or group may include a drug which may act as a culprit and impact metabolism of a victim drug in the pair or the group. For instance, a culprit drug may increase or decrease the amount of a victim drug by inhibiting or inducing an enzyme that is involved in the metabolism of the victim drug. In some examples, where more than two drugs are administered, there may be more than one culprit drug and/or more than one victim drug. Although the examples described herein may include a culprit and a victim drug, it is possible that two drugs in a pair may act as both a victim and as a culprit. Further, in some other examples, interactions between drugs in a pair or group may be described using a different term signifying the interaction; for instance, inhibitor drug and inhibited drug etc. Generally, the computational prediction may involve a prediction based on metabolic information (e.g. enzyme activity for particular metabolic pathways used in metabolism of at least one drug of the pair), while the clinical data may be based on clinical studies, trials, patient records, or the like. Based on the comparison, one or more correction factors may be identified for use in the computational prediction which results in an improved fit of the computational predictions with the clinical data. The correction factor may then be used in generating other computational predictions for substance-factor groups where no clinical data, insufficient clinical data, and/or suspect clinical data is available. In this manner, performance of a computational prediction based on metabolic factors may be improved through comparison of the predicted results with clinical data.

U.S. Pat. Nos. 8,099,298; 8,311,851; and 8,676,608, all of which are incorporated by reference herein in their entirety for any purpose, include examples of computationally predicting substance-factor interactions (e.g. drug interactions) in patients that may affect the amount of drug administered to a patient. Examples of the computational predictions include predicting the intensity of cytochrome and other metabolic enzyme interactions using parameters relating to drug and gene metabolism. Generally, the computational prediction may proceed by summing the effects on the AUC of multiple metabolic pathways utilized in a particular drug, e.g., victim drug, metabolism. A computational prediction system may return the computationally predicted change in AUC result for some substance-factor pairs, however, in some examples when clinical data is available, the clinical study based prediction may be returned by the prediction system rather than the computationally predicted change in AUC.

Clinical data may shed additional light on drug interactions, and examples described herein include examples of the use of clinical data to improve computational predictions of drug interactions, including for interactions where clinical data is unavailable, incomplete, and/or suspect. These improved computational predictions may aid in allowing physicians and healthcare workers to administer appropriate drugs and/or dosages to patients and to identify causes of adverse effects and causes for a lack of treatment effect.

Examples described herein include methods and systems for improving accuracy of prediction of substance-factor interactions in patients. Example systems may improve drug interaction prediction for a patient taking a drug by applying a correction factor to a computationally predicted change in AUC, or to a parameter used to generate the computationally predicted change in AUC. In some examples, the correction factor may be calculated by comparing a computationally predicted change in AUC for different substance-factor pairs or groups with change in AUC information derived from clinical data (e.g. clinical studies) for the corresponding pairs or groups. The improved prediction of the change in AUC may be used to set and/or change the amount or identity of the drug administered to a patient. The improved computational prediction of change in AUC may also be used to predict change in AUC of drugs for which no clinical data is available, or the clinical data is insufficient, and/or suspect. In some examples, when clinical data is available for a particular interaction, the clinical data rather than a computational prediction may be used to provide an interaction prediction.

Certain details are set forth below to provide a sufficient understanding of examples of the invention. However, it will be clear to one skilled in the art that examples of the invention may be practiced without various of these particular details. Systems and methods described herein may generally be used for improving prediction of any substance-factor interactions.

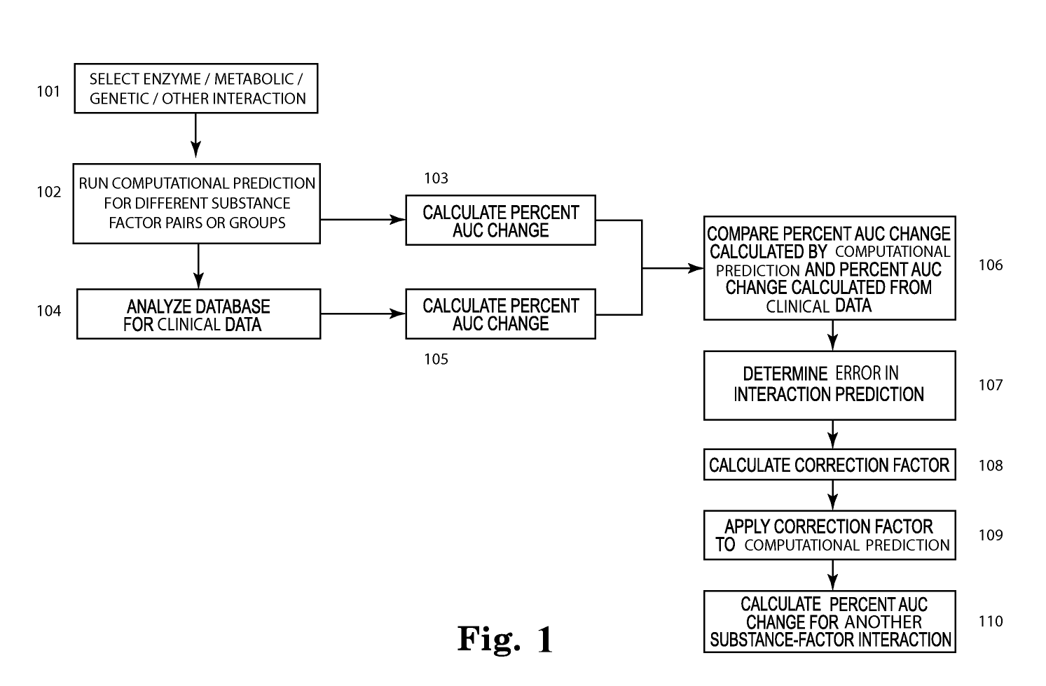

FIG. 1 is a schematic block diagram of a method for improved computational prediction of percent AUC change for a substance-factor interaction pair or group by comparing computationally predicted change in AUC of different substance-factor interaction pairs or groups with change in AUC based on clinical data for the pairs or groups. In block 101, a type of interaction may be selected for analysis. The selection may be made, for example, by a user of a system for improving drug interaction prediction, and may be received by the system. The type of interaction selected may be specific to one or more enzymes, metabolic pathways, genetic factors, environmental factors, or any other factors that the user may want to study. In block 102 a computational prediction of percent change in AUC of different substance-factor interaction pairs or groups is prepared, in which a computational prediction (e.g. predictive algorithm) and algorithm parameters may be selected. For example, a computational prediction may be carried out in any of a variety of manners, including those described in U.S. Pat. Nos. 8,099,298; 8,311,851; and 8,676,608, all of which are incorporated by reference herein in their entirety for any purpose. The computational prediction may generally include summing effects from multiple metabolic pathways used to metabolize the substance.

Substances may generally include anything to be administered to a patient, including drugs, foods or other materials. Factors may generally include anything that may affect the performance of that substance in the patient, including but not limited to, other substances (e.g. drugs), genes, demographic characteristics, and combinations thereof.

Different substance-factor interaction pairs or groups may be selected, in block 102, relevant to a specific type of interaction. For example, if a user intended to improve computational predictions related to enzyme CYP3A4, substance-factor interaction pairs or groups may be selected having CYP3A4 as a primary enzyme impacting the interaction. Substance-factor interaction pairs or groups may include, but are not limited to, drug-drug, drug-gene, drug-external factor or any other pair or group. In some examples, additional substances and/or factors may further be selected, such that an analysis of the interaction between three or more substances/factors may be analyzed, e.g. drug-drug-drug, drug-drug-gene, etc. Parameters may be selected, e.g. by a user of a prediction system and/or the improver system, for use in running the computational prediction.

In block 103, computational predictions of different substance-factor interaction pairs or groups, e.g. percent AUC change, are calculated and presented. In some examples, computational predictions of AUC change of different substance-factor interaction pairs or groups are based on metabolic information for the interaction pairs or groups.

In block 104, electronic storage (e.g. a database) may be analyzed for clinical data related to the type of interaction and/or substance-factor interaction pair or group to be analyzed. The clinical data may include, for example, data from clinical literature reporting actual changes in AUC due to particular substance-factor interaction pairs or groups. The clinical data may additionally or instead include data from patient records, including electronic health records. The data stored in the database may include data representative of a percent change AUC reflected by clinical studies, patient records, or combinations thereof for a particular substance-factor pair or group. The data selected to be analyzed may be retrieved from the storage for use in improving computational predictions, including for use in improving computational predictions for which the clinical data is not available, insufficient, suspect, or not desired.

Both percent change AUC—computationally predicted change AUC, 103, and change AUC from clinical data, 105—are compared in block 106 and an error in interaction prediction may be determined in block 107. For example, if the percent change in AUC from the computational prediction is greater or less than the percent change in AUC reflected in clinical data, it may be determined that an over or under prediction may have been made—in that, for example, the computational prediction may over predict a drug interaction based on the particular selected factor and/or enzyme, or conversely, under predict such an interaction relative to that which is reported in the clinical data.

Recall that a computational prediction system may return the results of computational predictions in some instances, but may in some examples instead return the percent AUC change consistent with clinical data when clinical data is available. Examples described herein may be utilized to improve the computational prediction system for those interaction pairs or groups for which clinical data is not available, insufficient, or suspect. In block 108, a correction factor may be provided based on the comparison of computationally predicted AUC change 103, and AUC change from clinical data, 105. The correction factor may be selected in a manner which considers a number of resulting over predictions, under predictions, overall accuracy of the computational prediction, and clinician's preferences as to cautiousness of clinical warnings, in some examples. For example, for a selected enzyme, a computational prediction may be made in block 103 for changes in AUC for multiple drugs due in part to the activity of that enzyme. In block 106, a comparison may be made to clinical data and a number of over predictions and/or under predictions may be evaluated. An overall accuracy of the prediction may further be evaluated, for example, a number of drugs for which the prediction remained within a threshold percent change AUC from agreement with the clinical data. A range of correction factors may be evaluated for the enzyme and/or selected factor, and a correction factor selected that meets predetermined criteria of over predictions, under predictions, accuracy and/or clinician's preferences. For example, a correction factor may be derived for different drug pairs or groups all of which are impacted by one enzyme, for instance CYP3A4, and only show one type of interaction, for instance, one of the drugs in a pair or a group may be a major substrate of the enzyme while the other drug(s) may be an inducer/inhibitor of the enzyme. In one example, a correction factor may be selected which maximizes accuracy of the computational prediction. In other examples, a correction factor may be selected which reflects a best accuracy while minimizing over predictions, as over predictions may in some examples cause physicians or other users of the system to ignore computational predictions with greater frequency, making the system less useful in some examples. In other examples, a correction factor may be selected which minimizes under predictions, as under predictions may be dangerous for patient health or outcome. The system described may allow intelligent explicit choices among competing clinical goals, e.g., not missing dangerous interactions but not warning unnecessarily and creating disbelief in the predictions.

In block 109, the correction factor may be used and applied to the computational prediction to provide an improved predicted change AUC. For example, a same computational prediction may be performed generally as performed in block 103, however, a numerical correction factor may be applied to the interaction using a specific enzyme or other interaction factor, which may change the AUC change predicted using the computational predictions. For example, the activity of the enzyme may be weighted more or less in accordance with the correction factor. The correction factor may in some examples be applied to other parameters (e.g. path size inhibition constant of a drug (Ki), systemic concentration (I), impact of inducer or inhibitor enzymes, or combinations thereof) used in the computational prediction. In another example, improved computational prediction using a correction factor may be used to predict percent AUC change for a substance-factor pair or group for which no clinical data is available. In some examples, this correction factor may be the same as the correction factor calculated in block 103 for different substance-factor interaction pairs or groups that involve the same interaction as involved in substance-factor interaction pair with no clinical data. The improved predicted AUC change may be used to calculate the dose of and/or select an identity of a drug administered to a patient. For example, a dose of a drug may be increased from a baseline recommended dose based on the improved predicted AUC change when the updated predicted AUC change indicates that a drug will be less active in a particular situation. A dose of a drug may be decreased from a baseline recommended dose based on the updated predicted AUC change when the updated predicted AUC change indicates that a drug will be more active in a particular situation. A different drug may be selected rather than a standard treatment drug when the updated predicted AUC change indicates that activity of that drug in a particular situation may be unacceptable to treat a condition or may result in unacceptable adverse effects. Similarly, as mentioned above, the improved computational prediction may also be used to calculate percent AUC change for an interaction pair or group which may have no clinical data, insufficient clinical data, suspect clinical data, conflicting clinical data etc.

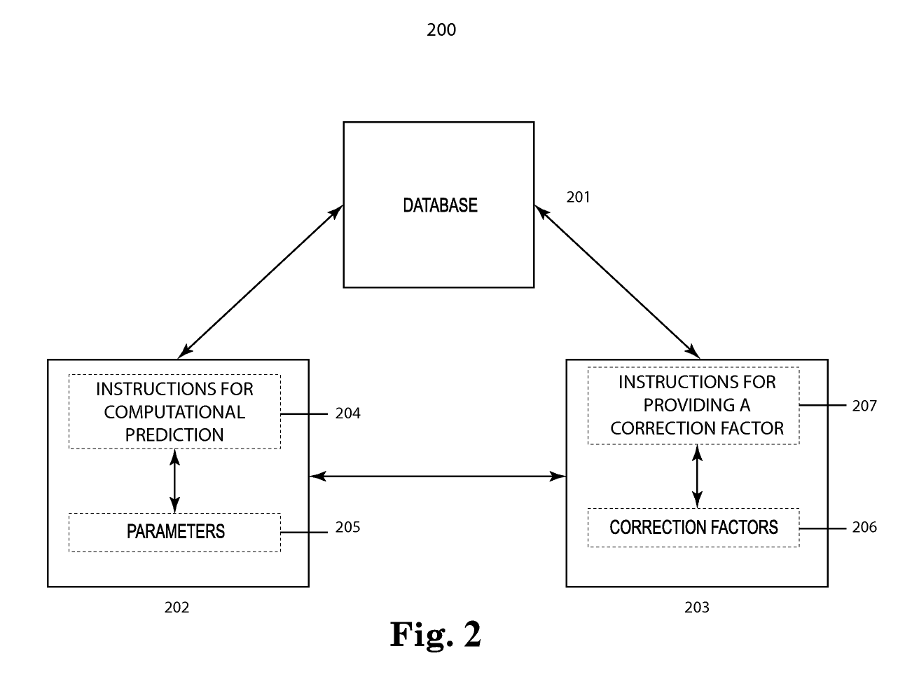

FIG. 2 is a schematic illustration of an example system for improving substance-factor interaction predictions. The system includes a database 201, connected to (e.g. in electronic communication with) a first computing system 202, and to a second computing system 203. The first computing system 202 and the second computing system 203 are in communication with each other. The first and second computing systems may each include one or more processing units (e.g. processors) and computer readable media (e.g. memory, electronic storage, drives) encoded with instructions causing the one or more processing units to perform the functions described herein. The computing systems may be implemented using, for example, computers, servers, desktops, laptops, PDAs, tablets, or cellular telephones. It is to be understood that the arrangement of computing components is quite flexible, and in other examples the functions may be performed by fewer or more computing systems than the two shown in FIG. 2.

The database 201 may include metabolic information and/or clinical data for substance-factor interactions (e.g. drug-drug interaction). The data may be gathered from clinical studies, medical records, such as electronic medical records, and/or other sources, as has also been described above with reference to FIG. 1.

The first computing system 202 may be programmed to perform a computational prediction in accordance with electronic instructions for computational prediction 204 which may be stored in a computer readable medium. Accordingly, the first computing system 202 may computationally predict a change in AUC for substance-factor interaction pairs or groups. The computational prediction instructions 204 in the first computing system 202 may be based on metabolic parameters 205 for calculation. The metabolic parameters may be stored in electronic storage (e.g. memory) 205, which may be integral with the first computing system 202, or may be in electronic communication with the first computing system 202.

The second computing system 203 may be programmed to compare the computationally predicted percent AUC change from the first computing system 202 with change percent AUC for corresponding substance-factor interaction pairs or groups, e.g. enzyme, based on clinical data. While shown as two separate computing systems, in some examples one computing system may perform the functions of both the first and second computing systems. The second computing system, 203, may also be programmed to generate one or more correction factors 206, based on the comparison of the computationally predicted percent AUC change with the percent AUC change from clinical data in accordance with instructions for providing a correction factor, 207. The correction factors 206 may be stored in electronic storage (e.g. memory), which may be integral with the second computing system 203 and/or may be in electronic communication with the second computing system 203. In some examples, the first computing system 202 may receive the correction factor 206 from the second computing system 203, and may execute the instructions for computational prediction 204 using the correction factor 206 to predict an improved change percent AUC. The updated percent AUC change may be used to calculate a correct dose or identity of a drug administered to a patient. In other examples, the first computing system 202 may receive the correction factor 206 from the second computing system 203, and may execute the instructions for computational prediction 204 using the correction factor 206 to predict percent AUC change for a drug interaction pair or group for which no clinical data, insufficient clinical data, suspect clinical data, conflicting clinical data etc. may be available.

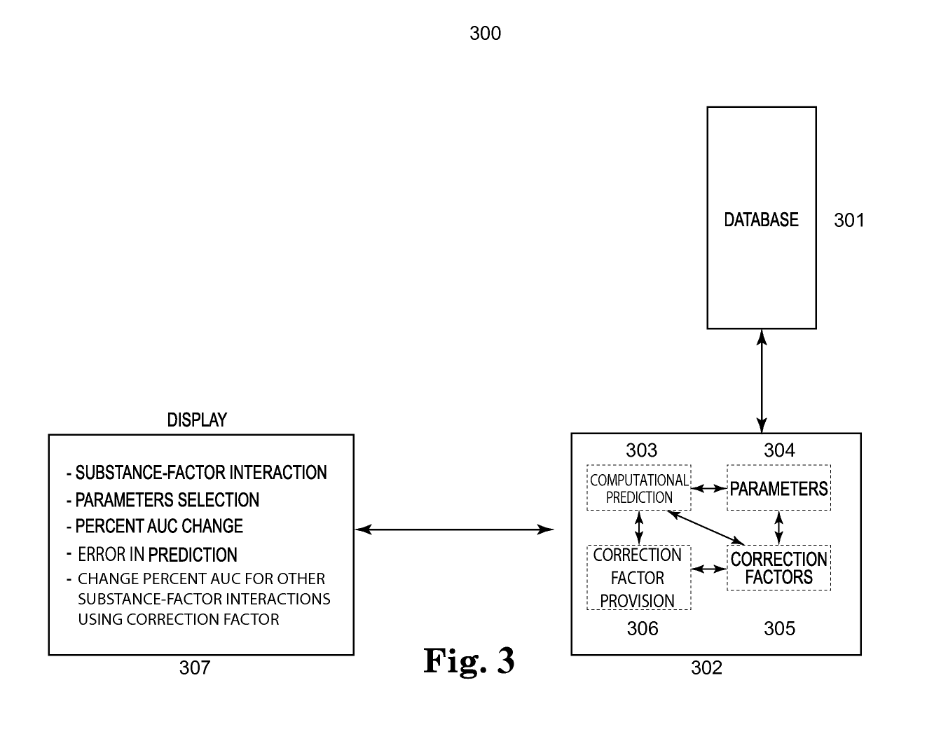

FIG. 3 is a schematic illustration of an example system. Unlike system 200, the system 300 includes a single computing system 302 in electronic communication with a database 301. The computing system 302 may similarly include one or more processing units (e.g. processors) and computer readable media (e.g. memory, electronic storage, drives) encoded with instructions for predictive computation 303 to computationally predict percent AUC change for drug groups or pairs using metabolic parameters 304. The computing system 302 may further be programmed to compare the computationally predicted change percent AUC with change percent AUC based on clinical data, calculate a correction factor 305 from the comparison using instructions for correction factor provision 306, and apply the correction factor 305 to the computational prediction 303 to predict an improved change percent AUC. The improved change percent AUC may be used to calculate the correct dose of the drug administered to a patient. The computing system 302 may also be programmed to apply the correction factor 305 to the computational prediction 303 to predict percent AUC change for a drug pair for which no clinical data, insufficient clinical data, suspect clinical data, conflicting clinical data etc. may be available. In this manner, a single computing system may be programmed to perform both the computational prediction and the provision of one or more correction factors described herein. However, as shown in FIG. 2, in other examples, multiple computing systems may perform these functions.

Referring back to FIG. 1, as mentioned above, in one example of the invention block 101 involves selection of a type of interaction, for instance, enzyme, metabolic, genetic, environmental etc. In block 102, a computational prediction of percent change in AUC of different substance-factor interaction pairs or groups is prepared. These substance-factor interaction pairs or groups may be a drug-drug pair, drug-gene pair, drug-external factor pair, drug-enzyme pair, or any other interaction pair or grouping for which a user may want to determine a change in AUC due to the interaction. The selection of an interaction pair or group may additionally or instead involve selecting a metabolic enzyme to determine and improve prediction of all substance-factor interactions impacted by the enzyme. In some examples, selection of a substance-factor pairs or groups (drug-drug pairs or groups may be used in this description by way of example, but it is to be understood that other pairs or groupings may additionally or instead be used) may include requirements so only appropriate pairs or groupings are selected for analysis. For instance, each pair or grouping selected may be checked, e.g. using the first computing system 202 of FIG. 2 or the computing system 302 of FIG. 3, for the particular interaction to be studied to determine no additional interactions between the pair or groupings are present that may impact the prediction.

However, in some examples, impact of different types of interactions on a substance-factor pair or grouping may also be studied. A point score may be assigned to different interactions using the improved computational prediction after updating the prediction using the correction factors provided in accordance with examples herein. The computational prediction may be performed multiple times to achieve an improved prediction of the interaction. For example, when determining a correction factor for drug-drug pair interactions for CYP2D6, drug-drug pairs which also have significant interaction involving CYP3A4 may be excluded from calculation of the correction factor for CYP2D6. In some examples, a significant interaction may be determined from clinical data by determining its effect on success of a correction factor in improved prediction. In some other examples, computational prediction permits balancing the rules of selecting drug-drug pair interactions for calculating correction factors with the desirability of maximizing the number of drug pairs or groups for a particular interaction to improve statistical reliability.

In some examples, where drug-drug pairs or groups with more than one interaction are selected, a cautious approach is taken while summing the scores for inhibition and induction interactions using the computational prediction. Points for each interaction may be added with the appropriate sign (negative for inhibition, and positive for induction). Another requirement for the substance-factor interaction pair to be analyzed in some examples may be excluding prodrugs, herbal drugs, and topical, ocular or any other drugs which are not usually absorbed systemically or lack information regarding dose of an active ingredient. Further, IV drugs may also be excluded because they may not be subject to first pass metabolism in the liver. On the other hand, two drug combinations (for instance, drug combinations often used in HIV/AIDS treatment) with studies available for the combined metabolic effects may be included for studying a substance-factor interaction.

In some examples, a user, which may be a person or another computational process, may select an enzyme and obtain predicted percent AUC changes for multiple drug pairs or groups impacted by the enzyme. For instance, CYP3A4 is one of the most common Cytochrome P450 enzymes involved in drug metabolism. A user may select CYP3A4 in block 101 of FIG. 1 such that one of the drugs in different drug pairs or groups is a major substrate of CYP3A4, for instance a victim drug, while the other drug may be an inhibitor/inducer of CYP3A4, for instance a culprit drug. If a drug pair includes a drug, e.g., the culprit drug, which induces CYP3A4 while another drug, e.g., the victim drug, is inhibited by CYP3A4, then administering the two drugs together would lead to a greater decrease in concentration of the second drug, the victim drug, in the body. A predictive percent change in AUC of the victim drug, may aid in modifying the drug dose to be administered.

In some examples, a user may select CYP2C9, CYP2D6, CYP2C19 or combinations of the enzymes in addition to or instead of CYP3A4. In other examples, additional or fewer enzymes may also be used. For example, the database 201 may be updated as more and more studies become available for metabolic enzymes and examples of methods and systems described herein may generally be used to predict change percent AUC for any enzyme or combination of enzymes.

Referring again to FIG. 1, a computational prediction may be selected in block 102. For example, the predictive computation specified by the instructions 204 and parameters 205 may be selected by a user. In some examples, a user interface may allow many parameters 205 to be input and/or adjusted to explore the computational prediction's success in prediction with various subsets of interactions and its sensitivity to various parameters. This may allow the user to select various quantitative measures of accuracy of a prediction. In some examples, the parameters 205 may include parameters that would impact a substance-factor interaction. A user can select such parameters to study their influence on the interaction. For instance, a user may select metabolic path size (e.g. percentage of drug metabolized through a particular metabolic route), inhibition constant of a drug (Ki), systemic concentration (I), impact of inducer or inhibitor enzymes or both, systemic concentration of inhibitor or inducer, drug-gene interaction, or combinations thereof. In one example, by repeatedly running the computational prediction 204 using different path size criteria, the impact of variations in drug pathway size on accuracy of prediction may be evaluated. For example, metabolic path size is often reported in literature as “major” or “minor.” A major pathway, in literature, is generally considered to be 50% or more. However, multiple major and minor pathways have been reported for a single drug by different authors. This may result in more than one major or minor pathway for a drug's metabolism. In such instances, reliance on literature may cause errors in percent AUC change calculations because of competing studies defining multiple major or minor pathways. Computational prediction, such as in block 102 of FIG. 1, in one example, may provide a unique way for assigning path sizes for a particular drug that may influence AUC change. This may be done by testing the accuracy of AUC change for different path sizes, where ambiguous and/or conflicting literature or other clinical data is available. Further, the impact of a number of drug metabolic pathways on accuracy may be evaluated. Research papers or other literature may usually report only one metabolic path for a drug per study, but how various paths interact in the total metabolism of a drug may be unclear. Examples of systems and methods described herein may reveal the clinically relevant path and path size with more precision. Selection of parameters 205 may allow a user to improve the accuracy of predicted percent AUC change for the substance-factor interaction pair. For example, repeated runs of computational predictions with varying definition of path size in some examples indicated that path sizes well below 100% do not substantially impact the correction factor calculated in block 108 of FIG. 1. Further, as additional drug or other interaction pairs become available for analyses of various parameters, such as pathway, path size, interfering interaction, etc., the accuracy of computational predictions may further increase.

In other examples, a user may run the computational prediction using the correction factors that may be calculated as described in block 102 and 103 and description above. This may aid the user in further improving the accuracy of predicted percent AUC change and impact of various interactions and parameters on a substance-factor interaction pair.

In block 102 of FIG. 1, a computational prediction, such as that encoded by the instructions 204 of FIG. 2, may be run to calculate a predicted percent AUC change 103. In some examples, the computational prediction may be run by selecting various parameters 205 that may impact accuracy of the prediction. A user may select these parameters based on importance of these to the user and the substance-factor interaction pair or group. In some examples, the computational prediction 204 calculates a predicted AUC change in block 103 for the interaction pair or grouping. The predicted AUC change may then be compared with AUC change based on clinical data calculated in block 105 from analysis of clinical data in the database 201. The predicted AUC change can be calculated using several calculation methods. In some examples for inhibition interactions the predicted AUC change may be based on three factors: inhibition constant of the inhibitor drug (Ki), CYP pathway (CYP3A4, CYP2D6 etc.), and pathway size for the inhibited drug (0-100%). In one example, the following formula may be used:

$$\frac{AUC ( + inhibitor )}{AUC ( control )} = \frac{1}{\frac{{f}_{mCYP}}{1 + [ I ] \text{/} {K}_{i}} + ( 1 - {f}_{mCYP} )}$$

In this formula, f_{mCYP} is the path size, [I] is the systemic concentration of the inhibitor drug, Ki is the inhibition constant of the inhibitor drug, and the (1−f_{mCYP}) term accounts for the fraction of metabolism which is not affected by the inhibitor drug. This may be the fraction that is impacted by a different CYP pathway.

For inducer drugs, for example, the AUC change for drug pairs in clinical data, such as literature, is usually defined with semi-quantitative ratings, such as mild, moderate, and potent inducer. During computational prediction, such as in block 102 of FIG. 1, it may be possible to more accurately predict AUC change by finding quantitative values for each semi-quantitative designation from the literature. For instance, selecting appropriate drug pairs, a user may vary the value assigned to each degree of inducer potency (e.g. based on the literature) to find which value predicts AUC change most accurately corresponding to AUC change from the clinical data.

In some examples, the following formula may be used:

$$\frac{{AUC}_{i}}{AUC} = \frac{{CL}_{int}}{{CL}_{int , i}} = 1 + \frac{[ I ]}{{K}_{i}}$$

Where CLᵢₙₜ is the clearance rate of a drug without the inhibitor and CL_{int,I} is the clearance rate of the drug with the inhibitor.

Referring back to FIG. 1, in one example of the invention, predicted AUC change may be compared with percent AUC change based on clinical data in block 106, followed by determining success of prediction in block 107, and calculation of a correction factor 206 in block 108, which may be performed by the second computing system 203 of FIG. 2 and/or the computing system 301 of FIG. 3. The correction factor 206 may be calculated and applied to the computational prediction in block 109. The correction factor may be provided using a linear extrapolation or calculated using statistical methods. In some examples, the correction factor may be based on an inhibited drug's CYP pathway. To find a correction factor for a CYP pathway, in some examples the computational prediction may be run on multiple interaction pairs (e.g. drugs) utilizing that CYP pathway and the computational predictions compared with corresponding clinical data. This process may be repeated over a range of possible correction factors for each CYP pathway. In some examples, a correction factor is selected for a CYP pathway, e.g. in accordance with the correction factor provision instructions of FIG. 2 or 3, which minimizes over predictions, minimizes under predictions, and maximizes correction predictions. In other examples, different criteria for a correction factor selection may be provided. For instance, in some circumstances it may be beneficial to minimize over prediction, more than under prediction. For instance, in clinical settings, physicians tend to ignore over prediction of interactions because they think that the program used grossly over-predicts interactions. However, in some examples, it may be beneficial to select a correction factor that gives more weight to minimizing over predictions so that physicians do not ignore warnings of over prediction and adjust the dose of a drug administered to a patient accurately based on predicted change in AUC. However, in other examples, where a clinician is trying to understand reasons for a side effect or treatment failure, it may be beneficial to select a correction factor such that minimizing over predictions is weighted less and more over predictions are shown to help the clinical identify a cause for the side effect or treatment failure.

As shown in FIG. 1, the correction factor calculated in block 108 is applied to the computational prediction in block 109 and an improved percent AUC change is calculated for the interaction. In some examples, the improved percent AUC change may be expressed as “points” which correlate to the AUC change. The points for inhibition and induction may be calculated as follows:

For inhibition: points=path size*(correction factor/Ki)

Ki refers to the inhibition constant of the inhibitor/culprit drug, while path size refers to a characteristic of inhibited/victim drug.

For induction: points=strength*multiplier

The induction strength may be described as a weak inducer, a moderate inducer, and a potent inducer, each with a numeric value. For example, Weak inducer=1; moderate inducer=2; Potent inducer=3. In some examples, computational prediction, such as in block 102 of FIG. 1, presents numeric strength in “points” that may correspond to clinical data, such as research studies in literature.

In some examples, the multiplier for poor metabolizers is—20; for moderate metabolizers—50; and for potent metabolizers—60. Other multipliers may be used in other examples.

As an example of the correlation between the points and percent AUC change; for instance, if points for a particular drug are greater than 100, then it indicates a change in percent AUC of greater than 100%.

Referring back to FIG. 1, in block 104 information in the database 201 of FIG. 2 may be analyzed (e.g. using the computing systems shown in FIGS. 2 and/or 3) to access percent AUC change from clinical data. In some examples, clinically studied interaction pairs may be divided in to four (4) categories of percent AUC change: Green, Yellow, Orange, and Red. Each category may have an associated range of percent AUC change that resulted from the pair's clinical data. The Green category, for example, may include interaction pairs or groups which show a less than 30% decrease or less than 25% increase in percent AUC on interaction. The Yellow category, for example, may include pairs or groups which show a 31-50% decrease or 26-75% increase in percent AUC on interaction. The Orange category, for example, may include pairs or groupings which show a 51-80% decrease or 76-200% increase in percent AUC on interaction, and a Red category for example may include pairs or groups which show an 81-100% decrease or greater than 200% increase on interaction. Although the categories are not of equal range, they may meet needs of busy clinicians. For example, Red warnings usually mean that the drug pair should receive very careful evaluation before administration to a patient. An Orange warning usually means that an interaction is likely and the risks and benefits of using the drug pair should be considered. A Yellow warning usually means that some interaction is likely but the clinician will likely accept the risk and be alert of unexpected side effects or treatment failure. Lastly, Green warnings usually mean that no significant interaction for the drug pair is predicted. In other examples, however, equal and/or different size groupings may be used; and/or different color categories may be used.

In some examples, the improved predictive percent AUC change is also presented according to the color categorization for percent AUC change. A visual indication of change in percent AUC may aid in catching attention of a user regarding change in percent AUC necessitating a change in the dose or identity of drug administered to a patient.

FIG. 1 also shows that in some examples, success of prediction of drug-drug interaction pairs or groups can be evaluated in block 107. One or more correction factors 206 of FIG. 2 may be used, in some examples, to balance minimizing over and under prediction and maximizing accuracy. In some examples, the success of prediction may be expressed as a percentage, when compared to change in AUC determined from clinical studies. In some examples, drug pairs may also be broadly categorized based on warning color for percent AUC change, as explained above. A predicted AUC change may be considered successful if it is no more than one warning color off from the warning color of AUC change calculated from clinical data. For instance, if a predicted AUC change shows a decrease of 31-50% (Yellow category) but the corresponding AUC change based on clinical data shows a decrease of 81-100% (Red category), then the predicted AUC is more than one warning color off of AUC change based on clinical data.

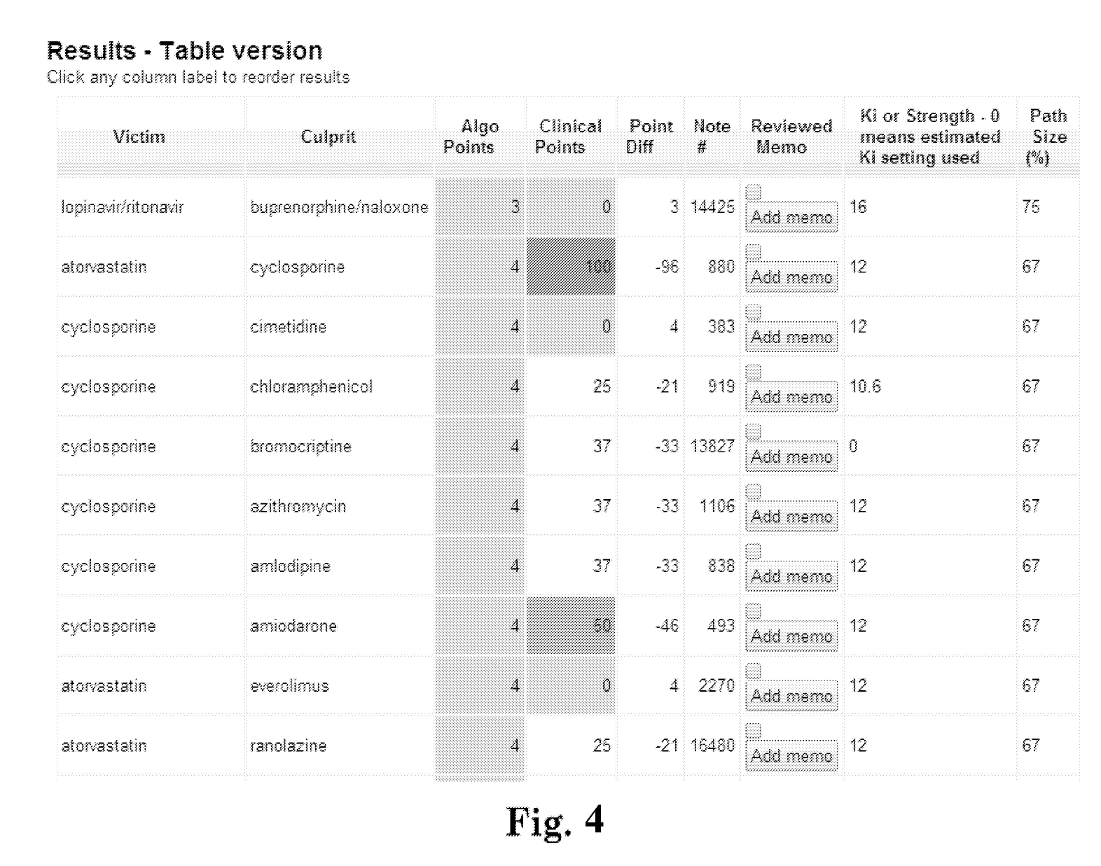

FIG. 4 shows, in some examples, output of computational prediction may be presented as a table showing substance-factor pairs (drug-drug pairs or groups may be used in this description by way of example, but it is to be understood that other pairs or groupings may additionally or instead be used) with corresponding points and/or warning colors for AUC change. In some examples, points, as described above, may be assigned for drug pairs for inhibitor/inducer drugs, while warning colors may be assigned as Green, Yellow, Orange and Red, also, as described above. The table may also contain information regarding parameters, such as Ki or path size selected for drug pairs. For instance, as shown in FIG. 4, drug pairs for CYP3A4 pathway, computational prediction for atorvastin/cyclosporine drug pair predicts 4 points while the corresponding clinical data shows 100 points. In one example, individual boxes for computational prediction and clinical data points may also be filled with a color. For instance, computational prediction box for atorvastin/cyclosporine pair may be Green, while the corresponding clinical data box might be Red. As described above, this may indicate to a user that in an atorvastin/cyclosporine pair there may be an over or under prediction of AUC because Green and Red categories are more than one color warning off. In some examples, this may also prompt a user to further evaluate path size, systemic concentration, Ki or any other parameters for the drug pair. However, in another example, for instance a cyclosporine/cimetidine pair, there may not be over and/or under prediction of AUC because both computational prediction and clinical data boxes may be Green. As the “Point Diff” column in FIG. 4 shows, some drug pairs show a positive point difference, while others show negative point difference. Thus, for instance, there is under prediction in some drug pairs, while over prediction in others. In some examples, a correction factor may be calculated, as in block 108 of FIG. 1, based on the differences between points predicted by computational prediction 103 and clinical data 105. As described in examples above, the correction factor may be selected which maximizes accuracy of the computational prediction across the examined interaction pairs or groups. In other examples, a correction factor may be selected which reflects a best accuracy while minimizing over predictions. In other examples, a correction factor may be selected which minimizes under predictions. The output shown in FIG. 4 may be displayed on a display by, for example, the computing system 202 and/or 203 of FIG. 2, and/or display 307 of FIG. 3.

FIG. 4, in another example, may also allow a user to arrange drug or other interaction pairs or groups such that the user may identify pairs or groups that are predicted poorly, as can be seen by differences in warning colors and points. This may prompt the user to investigate these poorly predicted pairs by analyzing underlying metabolic information and clinical data for the interaction pairs or groups. In some examples, this may lead to rejection of drug pairs that may be deemed “unpredictable” based on currently available information. In some examples, if a sufficient number of “unpredictable” drug pairs are available, computational prediction of block 102 of FIG. 1 may allow calculation of a correction factor 108 of FIG. 1 that may be applied to the computation prediction to improve prediction of “unpredictable” drugs.

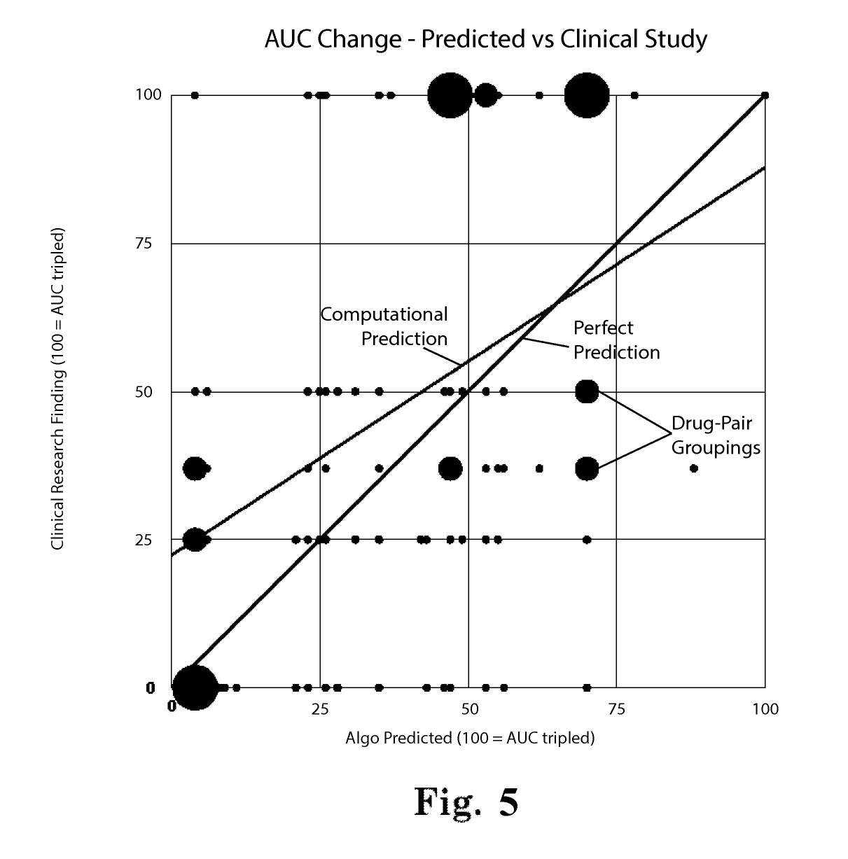

FIG. 5 is another example of presenting output of a computational prediction. As shown, output of computational predictions, for example, may be presented as a graph with the computational prediction of AUC change on x-axis and AUC percent change based on clinical data on y-axis. The graph may show a computational prediction trend line and/or a perfect prediction line. In one example, various drug pairs for CYP3A4 pathway may be grouped together as circles on the graph. The grouping of drug pairs may be based on warning colors. For instance, drug pairs with no more than one warning color difference between computationally predicted percent AUC change and AUC based on clinical data may be grouped as one color, while drug pairs with more than one warning color difference between the two AUCs compared as a different color. Further, sizes of circles may represent the number of drug pairs in that group. In some examples, the graph may show a distribution after applying a correction factor calculated in block 108 of FIG. 1 to computational prediction of block 102 of FIG. 1. FIG. 5 also shows that computational prediction of substance-factor interaction may be used to spot outlier predictions. A distribution of outlier predictions may prompt a user to explore the cause of outliers, which may be found by analyzing clinical data, such as scientific literature etc., stored in database 201 of FIG. 2.

### Example 1

Examples of methods and systems for improving drug interaction prediction described herein may be of great significance to the healthcare industry. Although physicians generally prescribe the same or similar medications and doses for a drug pair to patients, variations among patients (for instance, metabolic path size, metabolic path, CYP) may lead to unexpected effects. One patient may need more of a particular drug than another for the same indication due to various physiological factors. A physician may not know all the parameters impacting the drug pair interaction, or a physician may not be able to keep track of multiple parameters for individual patients. Increasing the accuracy of prediction may aid physicians to change or eliminate prescriptions and administer drug doses to patients more efficiently, minimizing side effects and treatment failures. A greater accuracy of prediction of drug interaction may also help minimize complications caused by drug interactions, and the healthcare industry would therefore be able to spend less money on hospitalization and care of people due to unintended drug interaction complications. An improved method for predicting drug interactions also helps reduce the necessity for tests like CT and MRI scans.

### Example 2

Examples of methods and systems for improving drug interaction prediction described herein may also be of significance for studying drug metabolism and drug interactions for which not much data is available clinically. For instance, in a study conducted on interactions of Delavirdine, a non-nucleoside reverse transcriptase inhibitor used in treatment of HIV infection, it was found using methods described herein that a significant number of interactions were under-predicted. In this study, drug pairs or groupings where Delavirdine is an inhibitor/inducer were run through computational predictions described herein, including CYP3A4 pathway. It was seen that 13 drug pairs were under predicted (at least by one color) and 5 pairs were grossly under predicted (e.g., more than one warning color off). These results provoked a reexamination of the clinical data which revealed that there was no definite data about the inhibitory strength of Delavirdine and only limited evidence that it was a potent inducer. Therefore, the inhibition strength of Delavirdine in the database 201 may be updated to reflect this finding. On running the computational prediction again, this change resulted in 12 drug pairs, with no under predictions and 5 over predictions (only two of these were gross over predictions). In all 12 drug pairs, Delavirdine was a victim drug. Thus, an improvement in understanding of drug interactions involving Delavirdine was achieved.

Examples described herein are not limited to application of substance-factor interactions in clinical settings involving administering an accurate drug dose to a patient. Examples may also be used for studying drug parameters (such as Ki, pathway, path size, systemic concentration etc.), studying drugs for which not much clinical literature is available, impact of different genes (drug-gene interactions) and other physiological factors (impact of smoking, pregnancy, food intake, disease states etc.) From the foregoing it will be appreciated that, although specific examples of the invention have been described herein for purposes of illustration, various modifications may be made without deviating from the spirit and scope of the invention.

What is claimed is:

1. A method for improving drug interaction prediction, the method comprising:
computationally predicting a percent AUC change for a drug based at least in part on an enzyme involved in a metabolic pathway for the drug, wherein said computationally predicting includes utilizing parameters for drug metabolism;
comparing the computationally predicted percent AUC change with a stored percent AUC change associated with the drug, wherein the stored percent AUC change is based on clinical data; and
providing a correction factor for the enzyme based on said analyzing.

2. The method of claim 1, further comprising computationally predicting a percent AUC change for another drug utilizing the correction factor.

3. The method of claim 1, wherein said comparing includes comparing the computationally predicted percent AUC change with stored percent AUC change for multiple drug interactions.

4. The method of claim 2 wherein no clinical data is stored for the another drug.

5. The method of claim 2, further comprising:
summarizing results of said comparing; and
displaying said drug with values indicative of said predicted percent AUC change, said stored percent AUC change, and said summarized results.

6. A method of claim 5 further comprising color-coding said percent AUC change in accordance with a plurality of warning levels.

7. A method of claim 5 further comprising displaying metabolic information for said drug.

8. A method of claim 5 further comprising displaying parameters used by said computationally predicting.

9. A method of claim 1 wherein said clinical data comprises data from electronic medical records, clinical studies, or combinations thereof.

10. The method of claim 2 further comprising recommending a dose of the drug, wherein the dose is based, at least in part, on said percent AUC change.

11. The method of claim 10, further comprising treating a patient with the dose of the drug.

12. A method of claim 1 further comprising selecting the enzyme.

13. A method of claim 1 wherein said computationally predicting utilizing parameters for drug metabolism includes a drug metabolic pathway.

14. A method of claim 1 wherein said computationally predicting utilizing parameters for drug metabolism includes a drug metabolic pathway size.

15. A method of claim 1 wherein said computationally predicting includes utilizing parameters including a drug inhibition constant.

16. A method of claim 1 wherein said drug interaction comprises a drug-gene interaction, a drug-drug interaction, or combinations thereof.

17. A method of claim 1 wherein said computationally predicting comprises summing change in the AUC due to multiple metabolic pathways.

18. A method of claim 1, further comprising computationally predicting a percent AUC change for multiple drugs utilizing the enzyme wherein said analyzing comprises analyzing a number of over predictions and a number of under predictions of the percent AUC change relative to the stored percent AUC change for the multiple drugs.

19. At least one computer-readable medium having stored thereon instructions that when executed by one or more processing units, cause the one or more processing units to improve drug interaction prediction, the instructions comprising instructions to:
receive identification of an enzyme, parameters for interaction prediction, or combinations thereof;
receive a computationally predicted percent AUC change for the drug based in part on the enzyme, wherein said computationally predicted percent AUC change is based, at least in part on parameters for drug metabolism;
analyze the percent AUC change against a stored percent AUC change for said drug, wherein the stored percent AUC change is based on clinical data; and
provide a correction factor based on said analyzing.

20. The computer-readable medium of claim 19, further comprising computationally predicting a percent AUC change for another drug utilizing the correction factor.

21. The computer-readable medium of claim 20 wherein no clinical data is stored for the another drug.

22. The at least one computer-readable medium of claim 19 wherein said clinical data comprises information from electronic medical records, clinical studies, or combinations thereof.

23. The at least one computer-readable medium of claim 19 wherein the instructions further comprise instructions for computationally predicting a percent AUC change for multiple drugs wherein said analyzing comprises analyzing a number of over predictions and a number of under predictions of the percent AUC change relative to the stored percent AUC change for the multiple drugs.

24. A system for improving drug interaction predictions, the system comprising:
a database storing clinical data regarding a plurality of drug interactions;
a first computing system wherein the first computing system is programmed to computationally predict a percent AUC change for a drug, based in part on at least one enzyme, using metabolism parameters; and
a second computing system, wherein the second computing system is in communication with the first computing system and the database, wherein the second computing system is programmed to:
compare the computationally predicted percent AUC change with a stored percent AUC change for the interaction pair stored in the database, wherein the stored percent AUC change is based on the clinical data; and
generate a correction factor based on the comparison; and
wherein the first computing system is configured to receive the correction factor and is further programmed to computationally predict a percent AUC change for another drug interaction using the correction factor.

25. The system of claim 24 wherein no clinical data is stored for the another drug.

26. The system of claim 24,
wherein said comparing includes comparing the computationally predicted percent AUC change with stored percent AUC change for multiple drug interactions.

27. A system of claim 24 wherein said second computing system is further programmed to receive a selection of said enzyme and at least one parameter utilized by said computational prediction.

28. A system of claim 24 wherein said parameter comprises a drug metabolic pathway.

29. A system of claim 24 wherein said parameter comprises a drug metabolic pathway size.

30. A system of claim 24 wherein said parameter comprises a drug inhibition constant.

31. A system of claim 24 wherein said drug interaction comprises a drug-gene interaction, a drug-drug interaction, or combinations thereof.

32. A system of claim 24 wherein the first computing system is further programmed to provide a treatment recommendation including a dose, wherein the dose is selected based, at least in part on the updated predicted change percent AUC.
